(19) United States
(12) Patent Application Publication
(10) Pub. No.: US 2020/0211728 A1
(43) Pub. Date: Jul. 2, 2020

(54) EXCITATION TRANSFER IMPLEMENTATIONS FOR NON-EXPONENTIAL DECAY OF RADIOACTIVE SPECIES

(71) Applicant: Industrial Heat, LLC, Raleigh, NC (US)

(72) Inventor: Peter L. Hagelstein, Carlisle, MA (US)

(21) Appl. No.: 16/810,889

(22) Filed: Mar. 6, 2020

Related U.S. Application Data
(63) Continuation of application No. PCT/US18/48981, filed on Aug. 30, 2018.
(60) Provisional application No. 62/555,569, filed on Sep. 7, 2017.

(51) Int. Cl. G21G 7/00; G21G 4/04

(52) U.S. Cl. CPC G21G 7/00; G21G 4/04

(57) ABSTRACT

A method of excitation transfer to a radioactive source is provided, the radioactive source having a natural radioactive decay rate. The method includes: energizing a stimulatory device coupled to a radioactive source, thereby exciting the radioactive source to decay at an enhanced rate that is higher than the natural radioactive decay rate. An excitation transfer apparatus includes: a support element; a radioactive source mounted on the support element, the radioactive source having a natural radioactive decay rate; a stimulatory device coupled to the support element; and a driver operatively connected to the stimulatory device to energize the stimulatory device, wherein upon energization, the stimulatory device excites the radioactive source which thereby decays at an enhanced rate that is higher than the natural radioactive decay rate.

### CROSS-REFERENCE TO RELATED APPLICATION

This application is a continuation of International Application No. PCT/US18/48981, filed on Aug. 30, 2018, entitled “EXCITATION TRANSFER IMPLEMENTATIONS FOR NON-EXPONENTIAL DECAY OF RADIOACTIVE SPECIES”, which claims the benefit of priority of U.S. provisional patent application No. 62/555,569, titled “NON-EXPONENTIAL DECAY IN X-RAY AND γ EMISSION LINES FROM Co-57,” filed on Sep. 7, 2017, which is incorporated herein in its entirety by this reference.

### TECHNICAL FIELD

The present disclosure relates generally to excitation transfer implementations, and more particularly to enhancing a rate of decay of a radioactive source.

### BACKGROUND

As with many emerging technologies, historic early announcements in this field were met with the skepticism by which scientific progress is forged. Reports of excess heat effects in electrochemical experiments with Pd in heavy water have thus been met with skepticism. The effects were theoretically unexpected and have been difficult to characterize. Subsequent observations of the effects support the contention that an excess heat effect does occur. However, available proposed explanations are not entirely accepted.

The absence of expected energetic nuclear radiation commensurate with the energy produced in such experiments should represent an avenue for investigation into both implementation and the advancement of related theoretical models, not an end to inquiries into this emerging science. A better understanding what goes on microscopically is of great interest. For example, in an incoherent deuteron-deuteron fusion reaction it is possible to observe p+t and n+3He to confirm the existence of the two dominant reaction pathways, and to measure the particle momenta and energies in order to shed light on the reaction kinematics. Without detecting known energetic reaction products, reaction mechanisms are difficult to discern and prove. Because of this, efforts to clarify unambiguously what nuclei are involved have not been entirely fruitful, but apparently these reactions do not behave entirely as conventional incoherent nuclear reactions.

Papers have been published describing a wide range of theoretical ideas as to how an excess heat effect might occur. Some of the proposals appear to be in conflict with experimental data due to the absence of predicted energetic radiation. For those which do not predict energetic radiation, it is difficult to make an unambiguous connection with all experiment data, since in general there are many things going on in such models, all of which have to work perfectly for excess heat to follow. Without independent experimental confirmation of at least some of the intermediate parts it is difficult to develop much confidence that any such model is correct. For example, there is currently interest in models based on a relativistic phonon-nuclear interaction, in which the absence of energetic nuclear radiation is accounted for through the subdivision of the 24 MeV quantum to lower energy transitions, and down-conversion of the nuclear excitation into a great many phonons.

While the theoretical arguments seem strong, without an unambiguous experimental confirmation of the phonon-nuclear coupling and of the down-conversion effect, it is difficult to be sure of the correctness of the model. From experience gained from the interaction of theory and experiments since first announcements of these heat effects, it seems there may never be universal agreement on what reaction mechanisms support prior experiments. What are needed are different but related experiments, in which the same mechanisms are involved, but which permit an unambiguous interpretation. Up-conversion experiments, in which vibrations are upconverted to produce nuclear excitation, have been proposed. Collimated X-ray emission in the experiments of Karabut, and of Kornilova and coworkers, for example, have been interpreted as due to the up-conversion of a great many vibrational quanta.

More recently an excitation transfer experiment has been proposed in which radioactive nuclei decay to produce nuclear excited states, where phonon exchange with a highly excited vibrational mode transfers the excitation to identical ground state nuclei located elsewhere. An up-conversion implementation would require the use of phonon-nuclear coupling, as well as the up-conversion mechanism; however, an excitation transfer implementation would require only phonon-nuclear coupling and relatively minimal energy exchange with vibrations. In this sense an excitation transfer experiment might be expected to be more accessible.

Theory motivates the use of a high frequency, as high as possible, but suitable commercial sources for THz vibration excitation are not readily available. Collimated X-ray emission in the Karabut experiment and in the Kornilova experiment seem to implicate lower frequency vibrations. Cardone and coworkers have reported a variety of effects in experiments in which a steel bar is subject to vibrations at 20 kHz; including neutron emission, alpha emission, and elemental and isotopic anomalies. Cardone and co-workers have interpreted their effects in terms of a model based on deformed space-time; however, it is possible to imagine that an up-conversion mechanism might be involved. All of this provides additional encouragement to postulate that up-conversion effects may be observed in experiments with vibrations well below the THz regime.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

In at least one embodiment, a method and a system are provided for vibrationally inducing an excitation transfer in a nuclear state, for example by vibrating a surface on which a nuclear species is fixed. The surface in at least one example is vibrated at a frequency near 2.21 MHz.

In at least one embodiment, a method of excitation transfer to a radioactive source is provided, the radioactive source having a natural radioactive decay rate. The method includes: energizing a stimulatory device coupled to a radioactive source, thereby exciting the radioactive source to decay at an enhanced rate that is higher than the natural radioactive decay rate.

In at least one embodiment, an excitation transfer apparatus includes: a support element; a radioactive source mounted on the support element, the radioactive source having a natural radioactive decay rate; a stimulatory device coupled to the support element; and a driver operatively connected to the stimulatory device to energize the stimulatory device, wherein upon energization, the stimulatory device excites the radioactive source which thereby decays at an enhanced rate that is higher than the natural radioactive decay rate.

Energizing a stimulatory device may include electrically energizing an ultrasonic transducer.

The ultrasonic transducer may have a resonance at a frequency greater than about two megahertz.

The radioactive source and the ultrasonic transducer may be mounted on opposite sides of a support element.

The support element may include a planar plate.

Mounting blocks may support and secure the planar plate along peripheral edges thereof.

The radioactive source may include a radioactive deposit on the planar plate.

The radioactive deposit may be covered by epoxy.

The radioactive source may include a beta emitter.

In at least one example, the radioactive source includes Co-57.

In at least one embodiment, a method inlcudes: providing a radioactive isotope on a substrate; and applying vibrational energy to the substrate, the vibrational energy having at least one frequency and a power level, to increase a rate of radioactive decay of the radioactive isotope.

The vibrational energy may be applied using a piezoelectric transducer affixed to the substrate.

The piezoelectric transducer may be on an opposite side of the substrate from the radioactive isotope.

The substrate may include a steel plate.

The at least one frequency may be about 2.21 MHz.

The vibrational energy may have a power of about 20 W or greater.

In at least one example, the radioactive isotope decays by a non-exponential decay due to the applied vibrational energy.

The at least one frequency may be about equal to a fundamental vibrational frequency of the substrate.

### BRIEF DESCRIPTION OF THE DRAWINGS

FIG. 1 is a schematic representation of an excitation transfer apparatus according to at least one embodiment.

FIG. 2 is a perspective view of an excitation transfer support element of the apparatus of FIG. 1, according to at least one embodiment.

FIG. 3 is a graph of transducer power as a function of frequency for a drive period of a transducer of the apparatus of FIG. 1, according to at least one embodiment.

FIG. 4 is a simplified version of the nuclear decay scheme for Co-57.

FIG. 5 is a time-integrated spectrum of an X-123 detector over an initial measurement period; raw counts (histogram fill) and an averaged spectrum (dark line) are shown.

FIG. 6 illustrates counts per hour (upper dots) on an Fe-57 nuclear transition at 14.4 keV as a function of time, and transducer power in watts (lower line plot) along the same time line.

FIG. 7 is a time history of the Fe-57 nuclear transition at 14.4129 keV data (dark circles), shown with an empirical fit (curved line along the dark circles), and an exponential decay curve (lower line plot) with 271.74 day half-life consistent with the standard empirical model.

FIG. 8 is a time history of the Fe Kα signal data points (dark circles), an empirical fit of the data (curved line along the data points), and an exponential decay plot with 271.74 day half-life consistent with the convention empirical model (lower line plot).

FIG. 9 is a time history of the Fe Kβ signal data points (dark circles), an empirical fit of the data (curved line along the data points), and an exponential decay plot with 271.74 day half-life consistent with the convention empirical model (lower line plot).

FIG. 10 is a time-integrated X-ray spectrum, for a particular period of implementation, in which raw counts are shown (see histogram).

FIG. 11 is a time history of the Sn Kα transition data points (dark circles) in which the decay is very nearly exponential with the expected 271.74 half-life.

FIG. 12 is a time history of the Sb Kα transition data points (dark circles) in which the decay is very nearly exponential with the expected 271.74 half-life.

FIG. 13 is a time history of the Ti Kα transition data points (dark circles); exponential decay with 271.74 day half-life consistent with empirical model.

FIG. 14 is a time history of the Geiger counter signal data points (dark circles), an empirical fit of the data (curved line along the data points), and an exponential decay plot with 271.74 day half-life consistent with the convention empirical model (lower line plot).

FIG. 15 is a time history of the spectrum of the Fe-57 nuclear transition at 14.4129 keV; the time axis (bottom) is in seconds; the channel number is on the left and the energy is on the right.

FIG. 16 plots the ratio of counts per 6 hours for the 14.4 keV gamma to the counts per 6 hours for the Fe Kα X-ray (dark circles), the ratio of empirical model fits (line along dark circles), and the ratio of exponential decay fits (lower line).

FIG. 17 is a time history of the Fe Kα signal data points (dark circles), an empirical model (curve along the data points), and peak transducer power (time varying plot of peaks).

### DESCRIPTION OF EMBODIMENTS

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

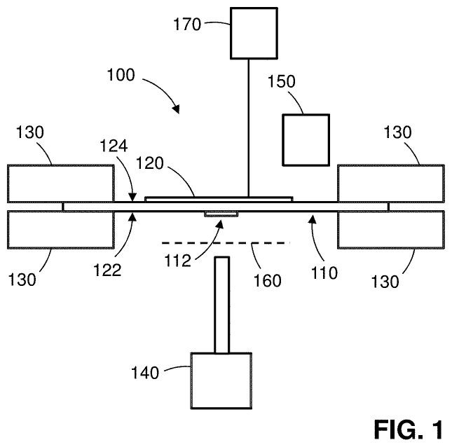

A schematic representation of an excitation transfer apparatus 100 is shown in FIG. 1, according to at least one embodiment. The apparatus 100 is useful to investigate and implement excitation transfer induced by vibrations near 2.21 MHz. By design, excited state Fe-57 is provided by the decay of Co-57, vibrations are applied, and a loss of the strength of the 14.4 keV nuclear transition at the site of the Co-57 is investigated when vibrations are present.

The apparatus 100 (FIG. 1) includes an excitation transfer support element 110 having a radioactive source 112. A stimulatory device 120 is coupled to the transfer support element 110 along a side thereof opposite the source 112. Mounting blocks 130 support and secure the excitation transfer support element 110 along peripheral edges. A first sensor 140 is located proximal the source 112 side of the excitation transfer support element 110, and a second sensor 150 is located proximal the stimulatory device 120 side of the excitation transfer support element 110 in the illustrated embodiment. Descriptions herein refer to the source 112 side of the excitation transfer support element 110 as the first or front side 122. Similarly, descriptions herein refer to the stimulatory device 120 side of the excitation transfer support element 110 as the second or back side 124. The stimulatory device 120 is operatively connected to and energetically driven by a driver 170, at least one embodiment of which is described below.

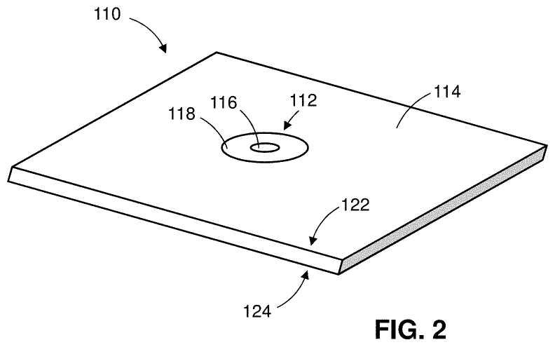

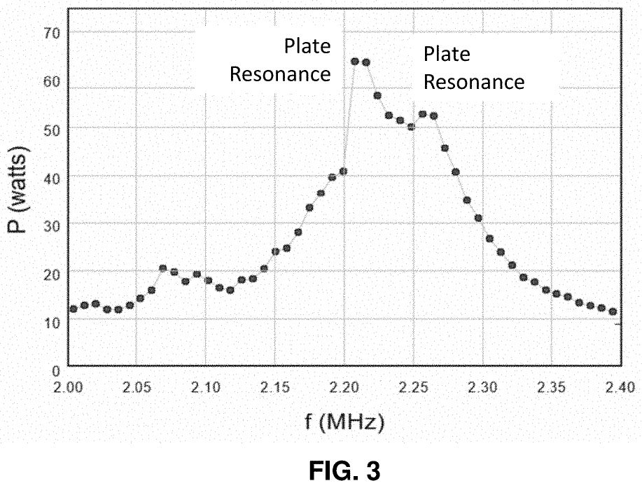

The excitation transfer support element 110 is separately shown in perspective view in FIG. 2. In at least one embodiment represented in FIG. 2, a rectangular 10 cm×18 cm piece of 5/32 inch thick steel plate serves as a planar support plate 114 or substrate upon which the source 112 is mounted. The uppermost mechanical vibrational peak of the n=3 fundamental resonance for this (loaded) plate 114 is observed around 2.22 MHz, as illustrated in FIG. 3, which is slightly below the transducer resonance. The corresponding longitudinal speed of sound in steel estimated from this frequency is 5.870×10⁵ cm/sec.

In at least one embodiment of the radioactive source 112, 1000 μCi (1 millicurie) of ⁵⁷CoCl2 was obtained from Eckert and Ziegler, in 0.1 M HCl, which came as 0.15 ml of solution in a 0.3 ml vial. Roughly ⅓ was deposited and evaporated onto the surface of the first side 122 of the support plate 114. The half-life of Co-57 is 271.8 days. By the time of the investigation, there was roughly 200 μCi remaining on the plate. The evaporated source deposit was covered by epoxy (J-B Weld 50112 Clear 25 ml ClearWeld Quick-Setting Epoxy Syringe) in order to prevent flaking off or physical loss of Co-57 activity. The evaporated Co-57 sample 116 is represented in FIG. 2 as the smaller region approximately one cm in diameter, and the epoxy covering 118 is represented as a layer approximately three cm in diameter over and surrounding the evaporated region.

In at least one embodiment, vibrations are driven by a high power 1 inch×6.5 inch piezo ultrasonic transducer, serving as the stimulatory device 120, rated for 1.95-2.07 MHz from PCT Systems Inc. For unloaded operation on Styrofoam, and for operation on steel, this transducer resonance was found to be higher (around 2.26 MHz). For mechanical coupling of the transducer to the support plate 114, VersaSonic® multipurpose high temperature ultrasonic couplant in gel form from ECHO Ultrasonics® was used. The transducer in such embodiment is electrically energized and driven by an E&I A150 Broadband Power Amplifier through an AR (Amplifier Research) Model DC2600A dual directional coupler, serving as the driver 170 in at least one embodiment.

In at least one embodiment, serving as the first sensor 140, for X-ray detection, an Amptek X-123 Si-PIN detector with a 0.5 mil Be window is used. For the data described herein, spectra were recorded roughly every minute and logged with a time stamp, using 2048 bins up to a maximum energy near 28 keV.

In at least one embodiment, serving as the second sensor 150, a Ludlum Geiger counter with a Model 44-88 Alpha Beta Gamma detector probe is used along with a Ludlum 2350-1 Data Logger to detect radiation on the back side of the plate. Counts are accumulated for one minute and logged with a time and date stamp.

In at least one embodiment, serving as the mounting blocks 130, four pieces of plywood are bolted down on the four respective corners of the rectangular support plate 114. Three holes were drilled in each piece of plywood for bolts, and nuts were secured using a torque wrench. In the illustrated embodiment, the evaporated Co-57 source 112 is on the planar first side 122 of the support plate 114, and a coarse aluminum protective mesh 160 resides between the first side 122 and the first sensor 140, for example the Amptek X-123, which directed to the first side 122. The second sensor 150, for example the Geiger counter embodiment, is directed to the planar second side 124 of the support plate 114, particularly in the illustrated embodiment, oriented over a free corner spaced from the radioactive source 112.

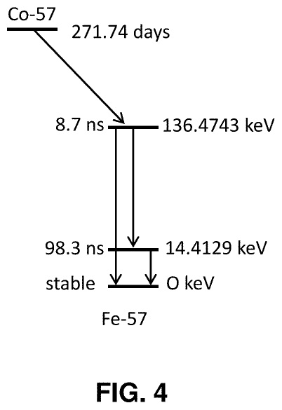

A simplified version of the nuclear decay scheme of Co-57 is shown in FIG. 4. Co-57 is a beta emitter that beta decays through electron capture, resulting 99.80% of the time in the excited state of Fe-57 at 136.47 keV. A small fraction of the time there is decay to higher energy Fe-57 states. The dominant gammas that result are the 14.4129 keV transition (which is widely used in Mossbauer studies), and two harder transitions at 122.0614 keV and at 136.4743 keV.

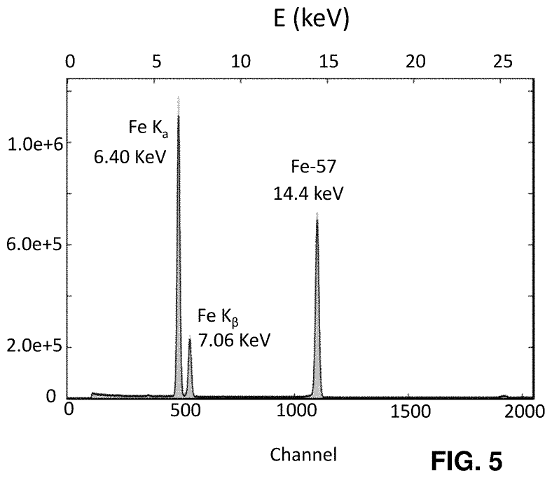

Time-integrated X-ray spectra are collected in at least one embodiment. A diagnostic sensor 140 in at least one embodiment is the Amptek X-123 detector. So as to characterize the equipment arrangement with respect to the X-rays and gamma lines. the X-123 spectrum integrated over the first few days of the experiment is shown in FIG. 5. The 14.4 keV gamma shows up clearly in the middle of the spectrum, and at lower energy the Fe Kα and Fe Kβ transitions are very strong. There is the possibility of Fe Kα or Fe Kβ radiative decay following the initial electron capture by Co-57; later on there is a substantial probability of Fe Kα or Fe Kβ radiative decay following the nonradiative decay of the 14.4 keV state by internal conversion.

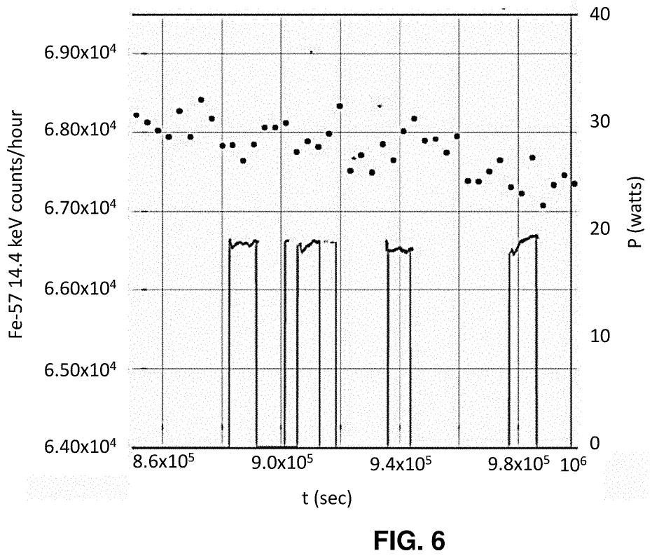

In an excitation transfer implementation, according to at least one embodiment, in which moderate transducer power is used, excitation transfer as described herein entails a reduction in the 14.4 keV gamma line when vibrations are driven. Late in the run, a protocol involving relatively long vibrations at modest (near 20 watts) transducer power was used. FIG. 6 shows the time history of counts per hour for the 14.4 keV line along with the transducer power. To construct this plot, the counts taken and logged each minute were added to determine one hour totals, which are plotted at the time (which in this case is relative to the start of the first day of the experiment) of the last minute of the accumulation. In FIG. 6 that there does not seem to be a significant dip in the emission when the transducer is driven. If there is a more general response of the emission strength to the vibrations, it is not particularly prominent in this data set. However, this question is revisited in connection with higher power operation below. The vertical axis scale on the left in FIG. 6 applies to the counts (upper dots), and the vertical axis scale on the right applies to the transducer power in watts (lower line plot) along the same time line.

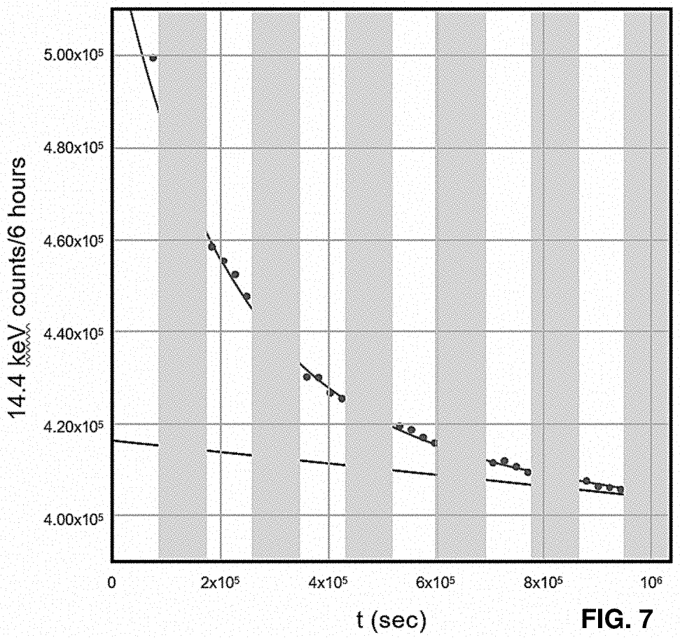

In implementing non-exponential decay of the Fe-57 14.4 keV gamma, which is the investigated effect, the radioactive Co-57 used has a half-life of 271.74 days. Thus, a minor reduction in the X-ray and gamma lines over the course of a multi-day investigation is expected. However, in this implementation there is instead an effect is observed in which the decay is not exponential. For example, results for the counts per 6 hour accumulation time for the Fe-57 14.4 keV gamma over the duration of a measurement period are shown in FIG. 7. The signal, as indicated by the circles indicating data points, is seen to decay much faster than would be expected given the long half-life of Co-57 indicated by the nearly straight sloped line low in FIG. 7. Thus, an enhanced decay rate is effected which is greater than the natural decay rate of the source, for example as determined by its natural half-life of 271.74 days. Alternating time bands in FIG. 7, and certain following drawings as well, mark the durations of days.

The arrival of counts during an accumulation time is governed by Poisson statistics, so that the standard deviation is the square root of the number of counts. For the data set presented the lowest number of counts is about 405000, for which the standard deviation is 636, which is on the order of the size of the circles used to plot the data. Here use is made of a relatively long accumulation time in part to minimize the spread, and in part to result in a simpler plot.

For this plot use is made of an empirical model given by:

$$ln I ( t ) \text{?} = - \frac{t}{τ} + a + {be}^{- t \text{/} {τ}_{0}} \\ \text{?} \text{indicates text missing or illegible when filed} \qquad ( 1 )$$

with T=271.74 days. From this model the intensity expected if no investigated effect were present can be estimated from:

$$ln {I}_{0} ( t ) \text{?} = - \frac{t}{τ} + a \\ \text{?} \text{indicates text missing or illegible when filed} \qquad ( 2 )$$

From a least squares fitting of the model parameters to the data T₀ is found as:

$${τ}_{0} \text{?} = 2.216 \times {10}^{5} sec \\ \text{?} \text{indicates text missing or illegible when filed} \qquad ( 3 )$$

which is a time constant associated with the physical configuration of the implementation, and not to any fundamental nuclear process. It is observed that this empirical model provides a good fit to the data.

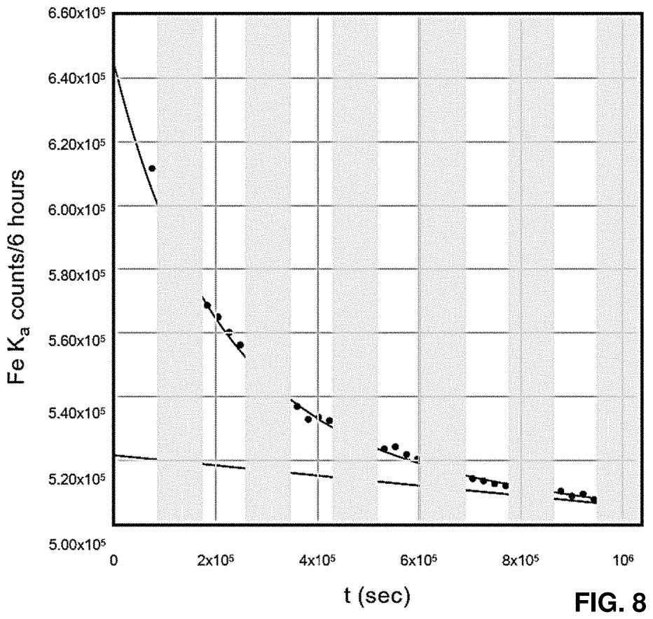

A similar non-exponential decay history is observed also for the Fe Kα X-ray, as shown in FIG. 8. It is expected that internal conversion of the 14.4 keV nuclear state would lead to Fe Kα emission, so it is expected that an effect qualitatively similar to the investigated effect is seen in the Fe Kα emission (the contribution from to the Fe Kα from the initial Co-57 capture is probably not affected, as will be discussed below). The empirical model above is again fit, with a time constant parameter of:

$${τ}_{0} \text{?} = 2.186 \times {10}^{5} sec \\ \text{?} \text{indicates text missing or illegible when filed} \qquad ( 4 )$$

which is within about 1% of what was found for the gamma transition.

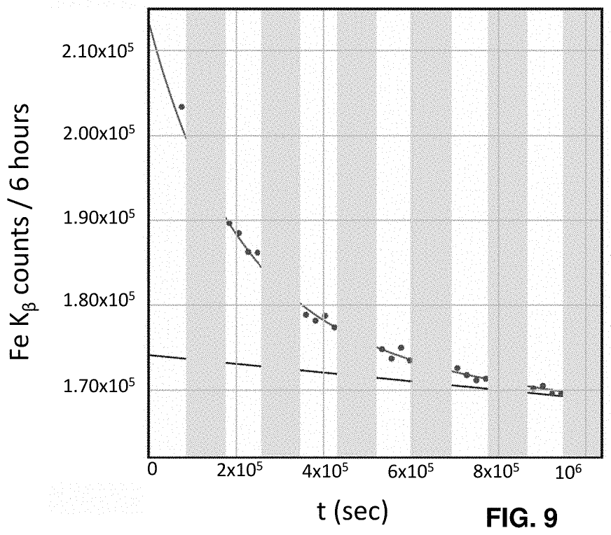

Similar dynamics of non-exponential decay are observed on the Fe Kβ transition as shown in FIG. 9 (as expected since the mechanism of Fe Kβ emission is very similar to that for Fe Kα). The time constant parameter in this case is essentially the same as for the previous cases:

T₀=2.273×10⁵ sec (5)

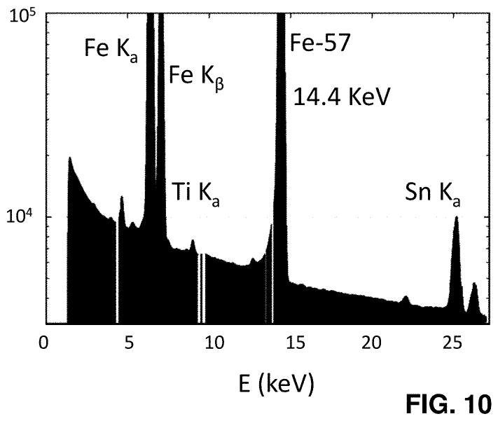

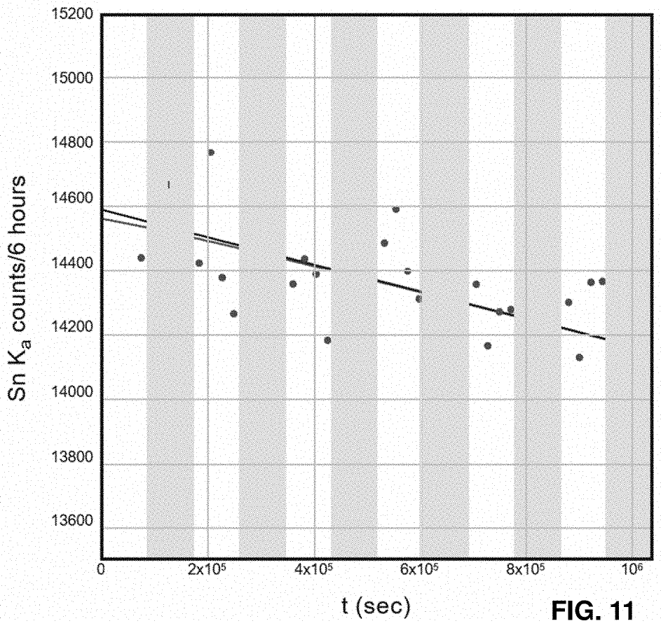

Nearly exponential decay of the Sn Kα X-ray is observed in at least one implementation embodiment. A line is present in the X-ray spectrum in the vicinity of 25 keV which has been identified as the Sn Kα X-ray (see FIG. 10) due to the presence of a small amount of tin in the steel plate. This line is interesting since it is present as a result of ionization due to the harder 122.1 keV and 136.5 keV gammas of the 136.5 keV state initially populated by the decay of Co-57. Because of this something can be learned about the dynamics of the 136.5 keV state indirectly, since in this investigation there are not direct measurements of the harder gammas. The results are shown in FIG. 11. It is seen that the decay is very nearly exponential with the expected half-life.

In this case the data has been fit to the empirical model assuming T₀=2.216×10⁵ sec. There appears to be a minor deviation from exponential decay from this analysis. It would be reasonable in this case to disregard this deviation as due to poor statistics. Note that subsequent experiments have shown a similar minor deviation with a reduction in counts at early time when the Geiger counter is placed on the back side near the Co-57, under conditions where the Geiger counter signal is dominated by contributions from harder gammas. This may be clarified by direct time-dependent measurements with a gamma detector capable of resolving the harder gammas.

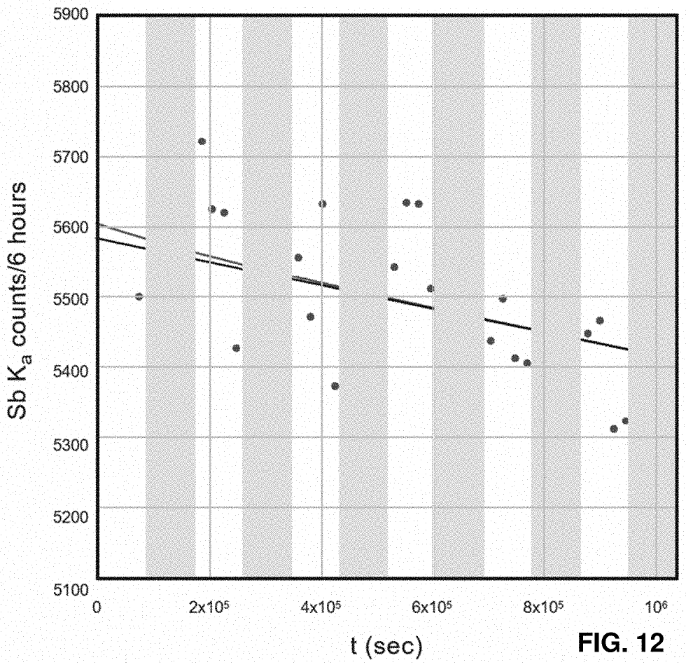

Nearly exponential decay of the Sb Kα X-ray is also investigated. A weak X-ray can also be seen at an energy higher than the Sn Kα which has been identified as the Sb Kα. From XRF measurements carried out on a similar piece of steel from the same supplier is believed that there is also a little bit of Sb present in the steel plate. One would expect to see a similar near exponential decay on this line as for the Sn Kα. The results shown in FIG. 12 indicate that this is true, as the resulting decay is close to exponential. The empirical fit leads to a minor deviation in the positive direction, supporting the conjecture that the small deviations in these two cases are a result of poor statistics.

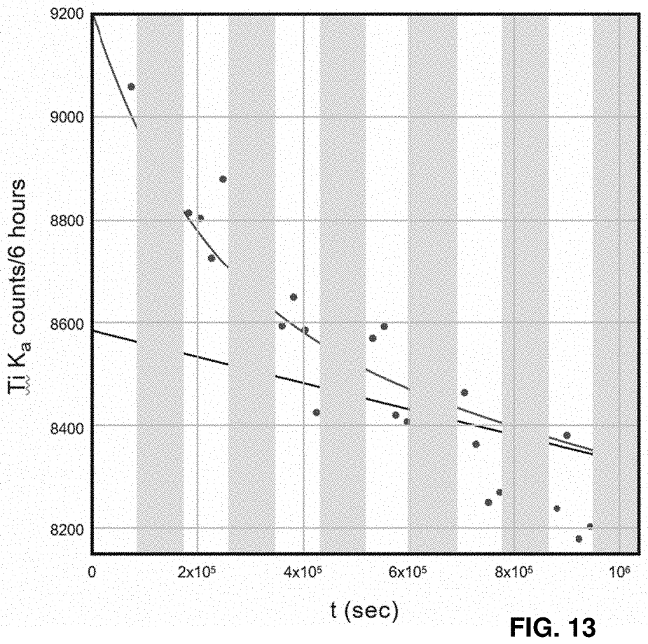

Non-exponential decay for the Ti Kα X-ray is observed. It is known from independent XRF tests that there is some titanium in the Al support mesh between the sample and X-123 detector, and it is possible to see the Ti Kα in the X-123 spectrum. An analysis of the dynamics of the emission from this line shows that it exhibits a non-exponential decay, although the effect is not as pronounced (see FIG. 13) as for the Fe Kα X-ray. Since the count rate is much lower there is more spread in the 6 hour accumulated data.

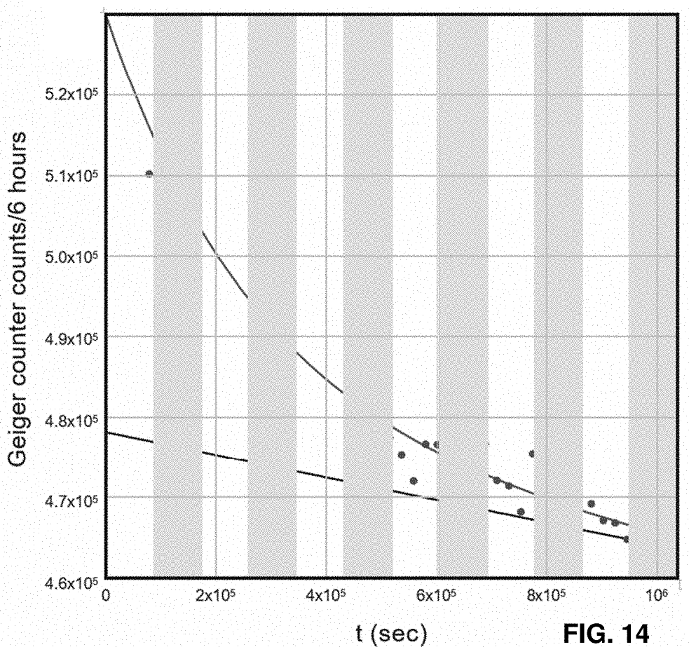

Non-exponential decay is observed in data of the back side Geiger counter signal. The Geiger counter is spaced from the back side 124 of the steel plate, and the plate is sufficiently thick that there is no possibility of the 14.4 keV gamma or the Fe Kα, Kβ X-rays from the Co-57 making it through the plate without being completely absorbed. Consequently, only the harder 122.1 keV and 136.5 keV gammas (and the much weaker gammas at higher energy) from the Co-57 make it to the back side. In this implementation, the Geiger counter is relatively distant from the Co-57 source, so that the signal strength due to the Co-57 is reduced by a factor of about 35 from what is measured in close proximity. It is known from the Sn Kα signal that the 122.1 keV and 136.5 keV gammas decay nearly exponentially. Consequently, the non-exponential decay of the Geiger counter signal shown in FIG. 14 is providing new information not available from the X-123 data.

In this case there was a significant period of data loss, so that there are fewer data points to work with. Nevertheless, it is clear that the decay in this case is very much non-exponential. The available data points, accumulated as above, have been fit to the empirical model once again. A reasonable fit is obtained with T₀=2.216×10⁵, but a lower error is found with:

T₀=2.879×10 sec (6)

Regarding admission near the 14.4 keV gamma as a function of time, if the 14.4 keV excited state of Fe-57 were created through some new process, there might be the possibility of a modification in the line shape. This provides the motivation to examine the spectrum in the vicinity of the 14.4 keV line up close.

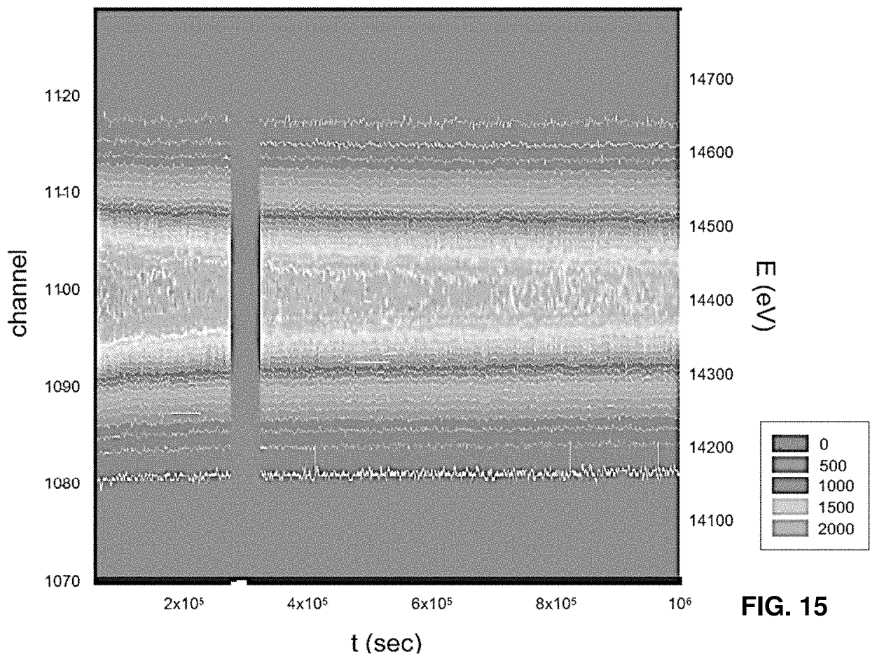

The spectrum as a function of time is shown in FIG. 15. Thirty minutes of data were summed for each time used in this plot. Some data loss is seen near 300000 seconds, and it can be seen clearly that the line is brighter at early times in the measurement. There seems to be a minor drift in the relative channel average, which may be due in part to a small drift in the detector gain (since the dynamics of the average relative channel is similar for the 14.4 keV X-ray and Fe Kα gamma).

Non-exponential decay for the 14.4 keV gamma, and for the Fe Kα and Kβ X-ray lines in this experiment is clearly observed in the above-described implementation. Some possible interpretations are considered below.

Possible issues with X-123 detector operation were considered against these observations. The first hypothesis considered was the possibility that the X-123 detector was functioning improperly in some way, perhaps losing counts over time. There are a number of arguments that can be made which weigh in against this. However, the strength of the roughly 200 μCi source is well within the operating range of the detector, so saturation effects are not expected. Furthermore, the observed decay of the Sn Kα and Sb Kα do not show significant anomalous time dependence; both are close to exponential with the expected half-life of 271.74 days.

The titanium Kα is produced predominantly by photoionization of K-shell electrons by the Fe Kα and Kβ X-rays. Consequently, if the emission of the Fe Kα and Kβ X-rays is enhanced at early time, the enhancement would expectedly be seen in the Ti Kα signal. We see from FIG. 13 that there is an enhancement at early time, which is consistent with photoionization from the observed Fe Kα and Kβ X-ray signals.

Since a protective mesh 180 is used between the sample and X-123 detector (first sensor 140, FIG. 1), it is possible for the relative motion to produce a change in the absorption by the mesh which might lead to either an increase or a decrease in the X-ray emission).

Arguing against this is the fact that the X-123 was secured by a sample holder, and the sample and wood blocks rested on some long screws. A substantial force (not present) would be required to move the detector, and a significant force (also not present) would have been needed to move the sample. In either case one would not expect a smooth exponential relaxation to appear in the signal as was observed. Note that the Geiger counter (second sensor 150, FIG. 1) is near on the back side 124 with no partial blocking by the aluminum mesh 160, and yet a similar non-exponential decay is observed.

The possibility of accelerated loss of Co-57 activity is considered. Claims have been put forth previously for the anomalous accelerated loss of radioactivity in other kinds of arrangements. Arguing against this in the implementation of FIG. 1 is the nearly exponential decay observed in the Sn Kα signal which is driven by the harder 122.1 keV and 136.5 keV gammas. Since the Fe-57 136.5 keV state is fed from the decay of Co-57 following electron capture, it is concluded that there is essentially no change in the decay rate of Co-57 or other loss of Co-57 activity in this implementation.

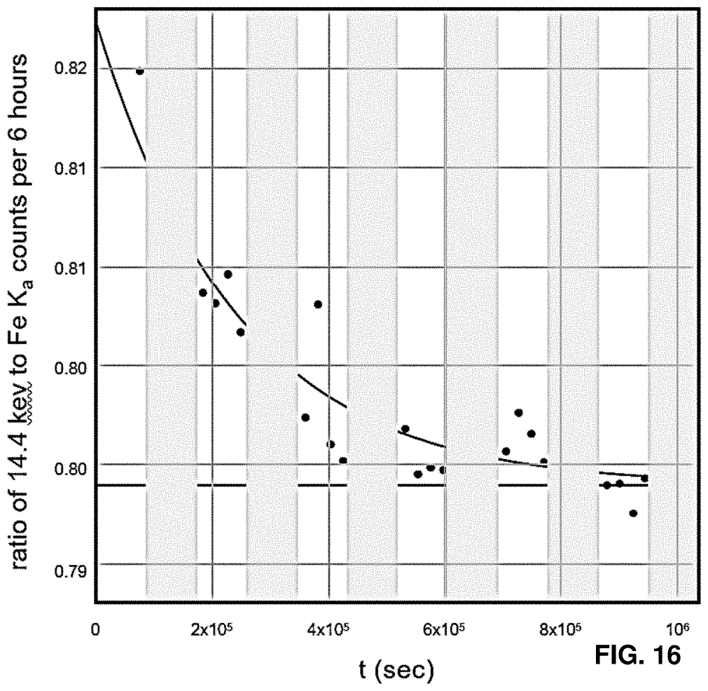

An independent argument can be made based on the fact that one would expect the ratio of the intensity of the 14.4 keV gamma to the Fe Kα to be constant if produced by a varying beta decay rate. In FIG. 16 the ratio of 14.4 keV gamma counts to Fe Kα X-ray counts is shown as a function of time, where a decrease in the ratio during the course of the experiment can be seen. This is inconsistent with a loss of Co-57 activity as an explanation for the effect.

The anomalous time-dependence of the emission of the 14.4 keV gamma, and Fe Kα and Kβ X-rays are interpreted as due to an increase in emission at early times, and not due to accelerated decay of Co-57. This increase of the emission is in response to vibrational stimulation.

Regarding a possibility of up-conversion of 2.21 MHz vibrations, a use of this implementation is toward determining whether MHz vibrations can be up-converted to produce nuclear excitation. As discussed briefly above, these results generally do not support this (see FIG. 6). Subsequent experiments have not shown a prompt response of the X-ray or gamma emission to the transducer power, which could be interpreted as supporting an up-conversion mechanism.

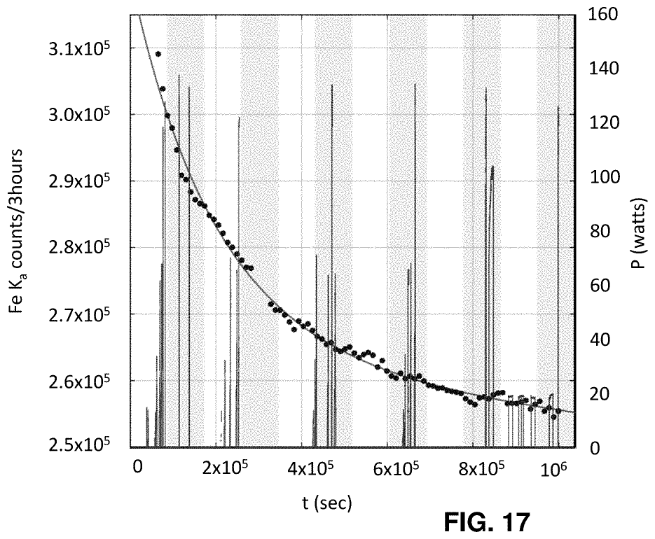

Regarding impact of 2.21 MHz vibrations on the investigated effect, given that the effect was present at the beginning of the measurement, it could be asked whether the vibrations that were imposed had any effect. To shed light on this, FIG. 17 illustrates the Fe Kα signal plotted along with the transducer power (peak power, with a 20% duty cycle so that the average power is less by a factor of 5). Transducer power was varied from about 20 W to 40W, 60W, 100W and 120W. The emission strength does not seem to increase or decrease much while the transducer is run. However, there is a weak response (increase) of the X-ray emission following some of the transducer pulses. While the effect is small in this implementation, it does clearly occur.

As to cause and effect, in the implementation of FIG. 1, enhancement is present at the start of the measurement, and the decay is observed. It was not certain at the time of the experiment what caused the investigated effect. It was initially assumed that something in the protocol used prior to data collection was responsible, with a focus on tightening the bolts on the blocks 130 and sample as perhaps relevant. Later measurements have shown that the investigated effect can be produced by tightening clamps, or by applying stress in other configurations. Also, the effect has been seen to occur much more clearly following transducer stimulation.

Many different embodiments have been disclosed herein in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In the specification, there have been disclosed embodiments of the invention and, although specific terms are employed, they are used in a generic and descriptive sense only and not for purposes of limitation. The following claim is provided to ensure that the present application meets all statutory requirements as a priority application in all jurisdictions and shall not be construed as setting forth the scope of the present invention.

What is claimed is:

1. A method of excitation transfer to a radioactive source, the radioactive source having a natural radioactive decay rate, the method comprising:
energizing a stimulatory device coupled to a radioactive source, thereby exciting the radioactive source to decay at an enhanced rate that is higher than the natural radioactive decay rate.

2. The method of claim 1, wherein energizing a stimulatory device comprises electrically energizing an ultrasonic transducer.

3. The method of claim 2, wherein the ultrasonic transducer has a resonance at a frequency greater than about two megahertz.

4. The method of claim 2, wherein the radioactive source and the ultrasonic transducer are mounted on opposite sides of a support element.

5. The method of claim 4, wherein the support element comprises a planar plate.

6. The method of claim 5, wherein mounting blocks support and secure the planar plate along peripheral edges thereof.

7. The method of claim 5, wherein the radioactive source comprises a radioactive deposit on the planar plate.

8. The method of claim 7, wherein the radioactive deposit is covered by epoxy.

9. The method of claim 1, wherein the radioactive source comprises a beta emitter.

10. The method of claim 9, wherein the radioactive source comprises Co-57.

11. An excitation transfer apparatus comprising:
a support element;
a radioactive source mounted on the support element, the radioactive source having a natural radioactive decay rate;
a stimulatory device coupled to the support element; and
a driver operatively connected to the stimulatory device to energize the stimulatory device,
wherein upon energization, the stimulatory device excites the radioactive source which thereby decays at an enhanced rate that is higher than the natural radioactive decay rate.

12. The excitation transfer apparatus of claim 11, wherein the stimulatory device comprises an ultrasonic transducer.

13. The excitation transfer apparatus of claim 11, wherein the ultrasonic transducer has a resonance at a frequency greater than about two megahertz.

14. The excitation transfer apparatus of claim 11, wherein the radioactive source comprises a beta emitter.

15. The excitation transfer apparatus of claim 14, wherein the radioactive source comprises Co-57.

16. The excitation transfer apparatus of claim 11, wherein the support element comprises a planar plate.

17. The excitation transfer apparatus of claim 16, wherein the planar plate has a planar first side upon which the radioactive source is mounted, and a planar second side opposite the first side, wherein the stimulatory device is coupled to the second side of the second side.

18. The excitation transfer apparatus of claim 17, wherein the planar plate is constructed of steel.

19. The excitation transfer apparatus of claim 11, further comprising mounting blocks that support and secure the support element along peripheral edges thereof.

20. The excitation transfer apparatus of claim 11, wherein the radioactive source comprises a radioactive deposit covered by epoxy.

21. A method, comprising:
providing a radioactive isotope on a substrate; and
applying vibrational energy to the substrate, the vibrational energy having at least one frequency and a power level, to increase a rate of radioactive decay of the radioactive isotope.

22. The method of claim 21, wherein the vibrational energy is applied using a piezoelectric transducer affixed to the substrate.

23. The method of embodiment 22, wherein the piezoelectric transducer is on an opposite side of the substrate from the radioactive isotope.

24. The method of claim 21, wherein the radioactive isotope comprises Co-57.

25. The method of claim 21, wherein the substrate comprises a steel plate.

26. The method of claim 21, wherein the at least one frequency is about 2.21 MHz.

27. The method of claim 21, wherein the vibrational energy has a power of about 20 W or greater.

28. The method of claim 21, wherein the radioactive isotope decays by a non-exponential decay due to the applied vibrational energy.

29. The method of embodiment 21, wherein the at least one frequency is about equal to a fundamental vibrational frequency of the substrate.
